(19) United States
(12) Patent Application Publication
(10) Pub. No.: US 2015/0138127 A1
(43) Pub. Date: May 21, 2015

(54) ELECTRONIC APPARATUS AND INPUT METHOD

(71) Applicant: KABUSHIKI KAISHA TOSHIBA, Tokyo (JP)

(72) Inventor: Yukihiro Kurita, Kokubunji Tokyo (JP)

(21) Appl. No.: 14/609,071

(22) Filed: Jan. 29, 2015

Related U.S. Application Data
(63) Continuation of application No. PCT/JP2013/057716, filed on Mar. 18, 2013.

(51) Int. Cl. G06F 3/041; G06F 3/0354

(52) U.S. Cl. CPC G06F 3/0416; G06F 3/03545
USPC 345/173

(57) ABSTRACT

According to one embodiment, an electronic apparatus comprises a touchscreen display and circuitry. The touchscreen display includes a first sensor and a second sensor, and is configured to display an user interface on a screen. The circuitry is configured to execute a first process when a first operation to the user interface through the first sensor is detected. The circuitry is further configured to execute a second process different from the first process when a second operation to the user interface through the second sensor is detected.

### CROSS REFERENCE TO RELATED APPLICATIONS

This application is a Continuation application of PCT Application No. PCT/JP2013/057716, filed Mar. 18, 2013, the entire contents of which are incorporated herein by reference.

### FIELD

Embodiments described herein relate generally to an electronic apparatus and an input method.

### BACKGROUND

Recently, various electronic apparatuses such as tablets, PDAs and smartphones have been developed. Many of these types of electronic apparatus comprise a touchscreen display to facilitate an input operation by the user.

The user can instruct the electronic apparatus to execute a function associated with a menu or an object displayed on the touchscreen display by touching the menu or object with a finger, etc.

Some touchscreen displays can accept not only an operation with a finger but also that with a pen (stylus). Since a position can be indicated more minutely in the operation with the stylus than in that with the finger in many cases, the operation with the stylus is appropriate for, for example, operating a small object displayed on a screen, writing characters by hand, etc.

Then, the user sometimes selectively uses the operation with the finger and that with the stylus when performing input using a touchscreen display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an outer appearance of an electronic apparatus according to an embodiment.

FIG. 2 is an exemplary block diagram showing a system configuration of the electronic apparatus according to the embodiment.

FIG. 3 is an exemplary block diagram showing a functional configuration of an application program executed by the electronic apparatus according to the embodiment.

FIG. 4 is an exemplary figure for describing a first example of an operation in accordance with input with a finger and a stylus in the electronic apparatus according to the embodiment.

FIG. 5 is an exemplary figure for describing a second example of an operation in accordance with input with a finger and a stylus in the electronic apparatus according to the embodiment.

FIG. 6 is an exemplary figure for describing a third example of an operation in accordance with input with a finger and a stylus in the electronic apparatus according to the embodiment.

FIG. 7 is an exemplary figure showing an example of an operation table used by the electronic apparatus according to the embodiment.

FIG. 8 is an exemplary flowchart showing an example of procedures of input processing executed by the electronic apparatus according to the embodiment.

### DETAILED DESCRIPTION

Various embodiments will be described hereinafter with reference to the accompanying drawings.

In general, according to one embodiment, an electronic apparatus comprises a touchscreen display and circuitry. The touchscreen display comprises a first sensor and a second sensor, and is configured to display an user interface on a screen. The circuitry is configured to execute a first process when a first operation to the user interface through the first sensor is detected. The circuitry is further configured to execute a second process different from the first process when a second operation to the user interface through the second sensor is detected.

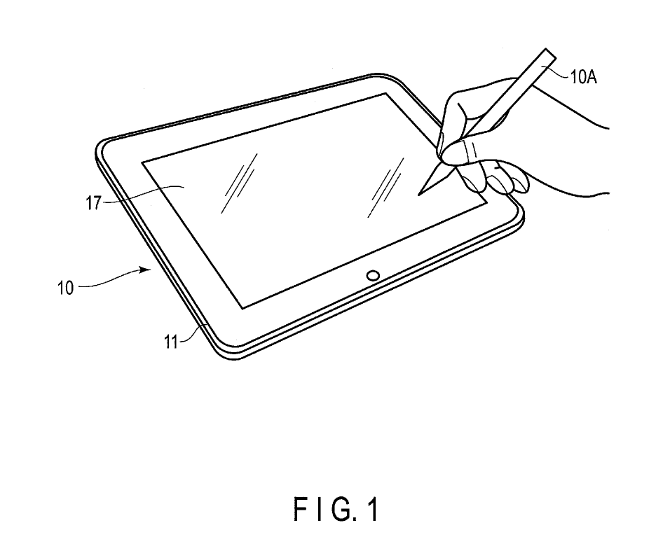

FIG. 1 is an exemplary perspective view showing an outer appearance of an electronic apparatus according to an embodiment. The electronic apparatus is, for example, a portable electronic apparatus allowing writing by hand with a stylus or a finger. The electronic apparatus can be realized as a tablet computer, a notebook computer, a smartphone, a PDA, etc. A case where the electronic apparatus is realized as a tablet computer 10 will be hereinafter assumed. The tablet computer 10 is a portable electronic apparatus also called a tablet or a slate computer, and comprises a main body 11 and a touchscreen display 17, as shown in FIG. 1. The touchscreen display 17 is attached to an upper surface of the main body 11 in piles.

The main body 11 comprises a thin box housing. A flat panel display and a sensor configured to detect a contact position of a stylus or a finger on a screen of the flat panel display are mounted in the touchscreen display 17. The flat panel display may be, for example, a liquid crystal display (LCD). As the sensor, for example, a capacitance type touch panel (first sensor) or an electromagnetic induction type digitizer (second sensor) can be used, but the sensor is not limited to them. Any sensor can be used as the first sensor and the second sensor, if contact between a stylus or a finger and a screen can be distinguishably detected. The first sensor and the second sensor may be mounted on single H/W or different types of H/W. A case where both of two kinds of sensors, that is, the digitizer and the touch panel are mounted in the touchscreen display 17 will be hereinafter assumed.

Each of the digitizer and the touch panel is provided to overlap a screen of a flat panel display. The touchscreen display 17 can detect not only a touch operation (contact operation) with a finger on a screen but also a touch operation (contact operation) with a stylus 10A on the screen. The stylus 10A may be, for example, an electromagnetic induction stylus. The touch panel (first sensor) can detect contact between the finger and the touchscreen display 17. Also, the digitizer (second sensor) can detect contact between the stylus 10A and the touchscreen display 17. The user can perform various gesture operations such as tap, drag, swipe and flick on the touchscreen display 17 using the stylus 10A or the finger.

Further, the user can write by hand on the touchscreen display 17 using the stylus 10A. During the operation of writing by hand, a locus based on motion of the stylus 10A on a screen, that is, a stroke made while writing by hand (locus of handwritten stroke) is drawn in real time, and a plurality of strokes made while writing by hand (locus of each handwritten stroke) are displayed on the screen.

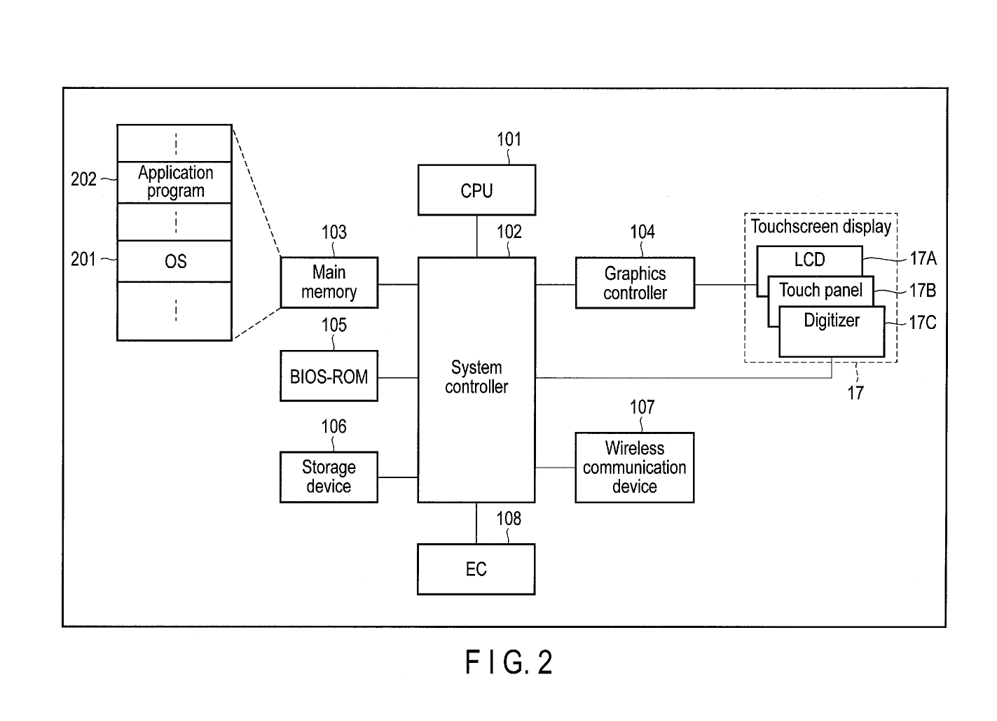

FIG. 2 is an exemplary block diagram showing a system configuration of the tablet computer 10 according to the embodiment.

The tablet computer 10 comprises a CPU 101, a system controller 102, a main memory 103, a graphics controller 104, a BIOS-ROM 105, a storage device 106, a wireless communication device 107, an embedded controller (EC) 108, etc., as shown in FIG. 2.

The CPU 101 is a processor which controls an operation of various modules in the tablet computer 10. The processor includes circuitry. The CPU 101 executes various programs loaded from the storage device 106 into the main memory 103. The programs executed by the CPU 101 comprise an operating system (OS) 201 and various application programs 202. The application programs 202 comprise, for example, a handwritten character recognition program, a browser program, an image editing program, a document creation program and a mailer program.

Further, the CPU 101 executes a basic input/output system (BIOS) stored in the BIOS-ROM 105. The BIOS is a program for hardware control.

The system controller 102 is a device which connects between a local bus of the CPU 101 and various components. A memory controller which performs access control on the main memory 103 is also mounted in the system controller 102. Also, the system controller 102 comprises a function of performing communication with the graphics controller 104 through a serial bus, etc.

The graphics controller 104 is a display controller which controls an LCD 17A used as a display monitor of the tablet computer 10. A display signal generated by the graphics controller 104 is transmitted to the LCD 17A. The LCD 17A displays a screen image based on the display signal. A touch panel 17B is arranged on an upper layer of the LCD 17A as a first sensor for detecting a contact position of the finger on a screen. Furthermore, a digitizer 17C is arranged on a lower layer of the LCD 17A as a second sensor for detecting a contact position of the stylus 10A on a screen. The touch panel 17B is a capacitance type pointing device for performing input on a screen of the LCD 17A. A contact position of a finger on a screen and motion of the contact position, etc., are detected by the touch panel 17B. The digitizer 17C is an electromagnetic induction type pointing device for performing input on a screen of the LCD 17A. A contact position of the stylus 10A on a screen and motion of the contact position, etc., are detected by the digitizer 17C.

An OS 201 issues an input event indicating that the finger contacted the screen and indicating the contact position, in liaison with a driver program that controls the touch panel 17B. Further, the OS 201 issues an input event indicating that the stylus 10A contacted the screen and indicating the contact position, in liaison with a driver program that controls the digitizer 17C.

The wireless communication device 107 is a device which performs wireless communication such as a wireless LAN and 3G mobile communication.

An EC 108 is a single-chip microcomputer comprising an embedded controller for power management. The EC 108 comprises a function of powering on or off the tablet computer 10 in accordance with the operation of a power button by the user.

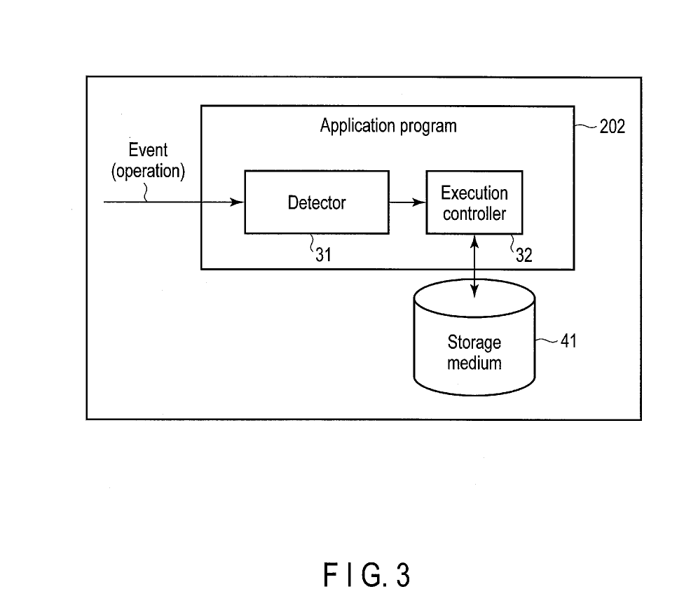

Next, a functional configuration realized by the application program 202 in this embodiment will be described with reference to FIG. 3. The CPU 101 realizes functions of a detector 31, an execution controller 32, etc., by executing the application program 202. It should be noted that the functional configuration shown in FIG. 3 may be realized by the OS 201. That is, the CPU 101 can realize the functions of the detector 31, the execution controller 32, etc., by executing the OS 201. In other words, the functional configuration shown in FIG. 3 can be incorporated into various types of software executed by the CPU 101.

The detector 31 detects an operation to an object displayed on a screen of the LCD 17A. The object is an object of a graphical user interface (GUI) which can be operated by the user such as a button, an icon and an input area. The detector 31 can detect a first operation to an object with the finger through, for example, the touch panel (first sensor) 17B. Further, the detector 31 can detect a second operation to an object with the stylus 10A through, for example, the digitizer (second sensor) 17C.

More specifically, the detector 31 receives an input event issued by the OS 201. As described above, the OS 201 issues a first input event indicating that the finger contacted the screen and indicating the contact position, motion of the contact position, etc., in liaison with a driver program that controls the touch panel 17B. That is, the OS 201 issues the first input event according to a touch operation with the finger on the screen. The detector 31 receives the issued first input event, and detects the first operation to an object with the finger if the contact position of the finger indicated in the first input event is within an area corresponding to an object on a screen.

Furthermore, the OS 201 issues a second input event indicating that the stylus 10A contacted the screen and indicating the contact position, motion of the contact position, etc., in liaison with a driver program that controls the digitizer 17C. That is, the OS 201 issues the second input event according to a touch operation with the stylus 10A on the screen. The detector 31 receives the issued second input event, and detects the second operation to an object with the stylus 10A if the contact position of the stylus 10A indicated in the second input event is within an area corresponding to an object on a screen.

The detector 31 outputs the detected operation (or the received input event) to the execution controller 32.

The execution controller 32 controls execution of processing based on the operation detected by the detector 31. The execution controller 32 executes first processing if the first operation is detected, and executes second processing different from the first processing if the second operation is detected.

More specifically, the execution controller 32 executes the first processing associated with the operation with the finger if the detected operation is the first operation. Further, the execution controller 32 executes the second processing associated with the operation with the stylus 10A if the detected operation is the second operation. The first processing comprises processing of displaying a GUI suitable for an operation with the finger (for example, icon, button, etc., easily selected with a finger) to provide a function suitable for the operation with the finger. The second processing comprises processing of displaying a GUI suitable for an operation with the stylus 10A (for example, input area for writing characters or drawing a figure by hand with the stylus 10A, etc.) to provide a function suitable for the operation with the stylus 10A.

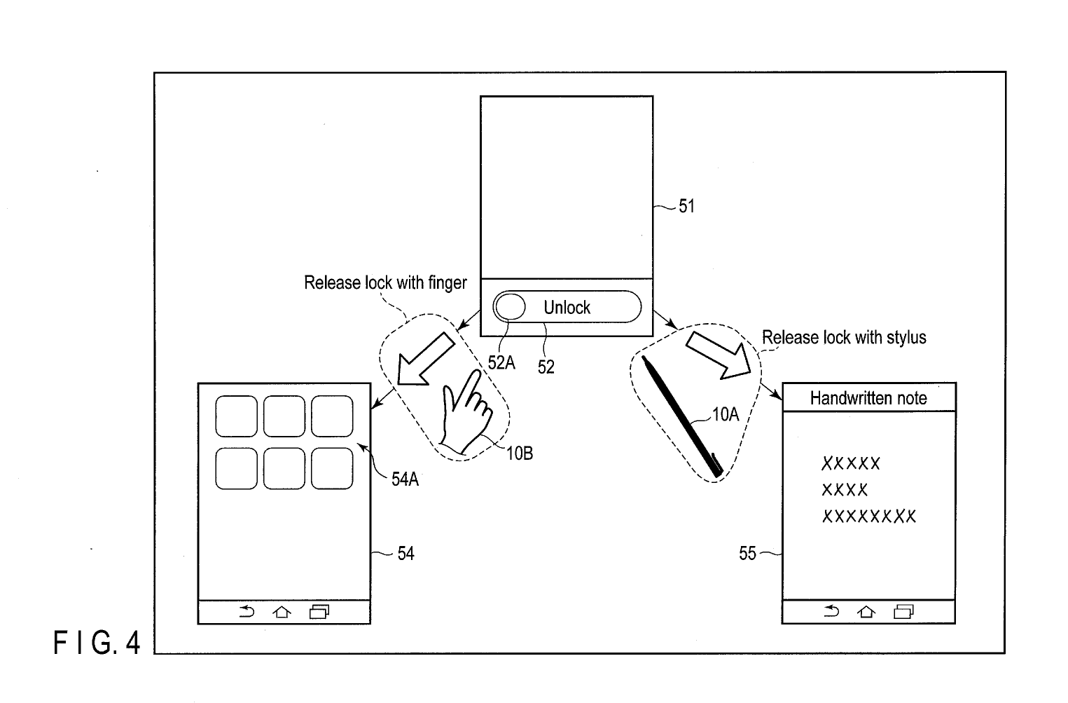

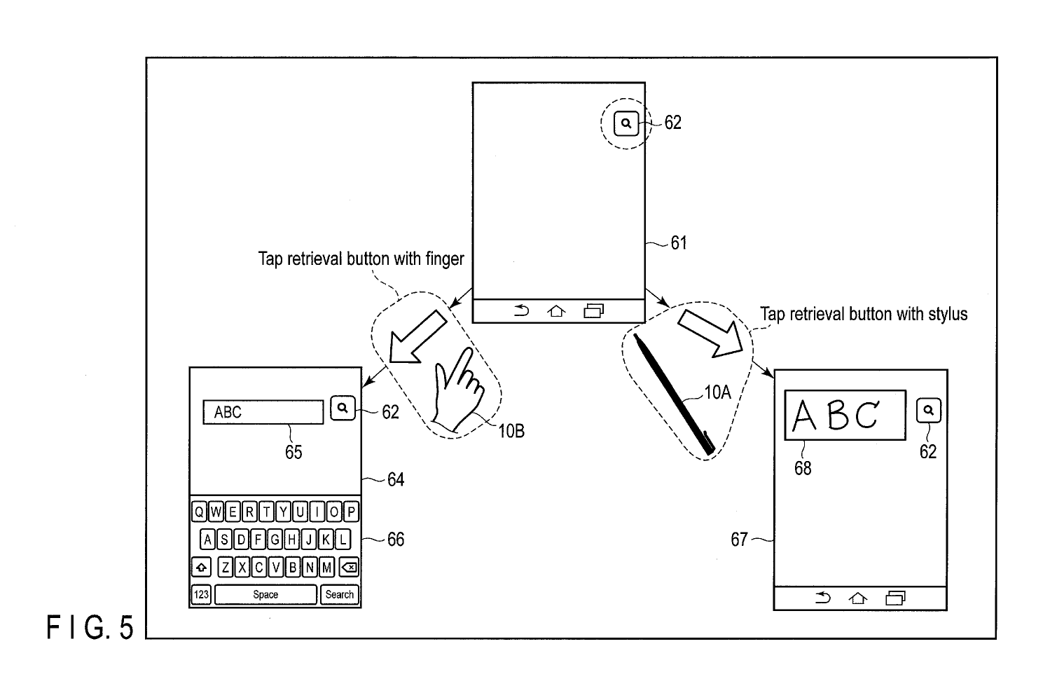

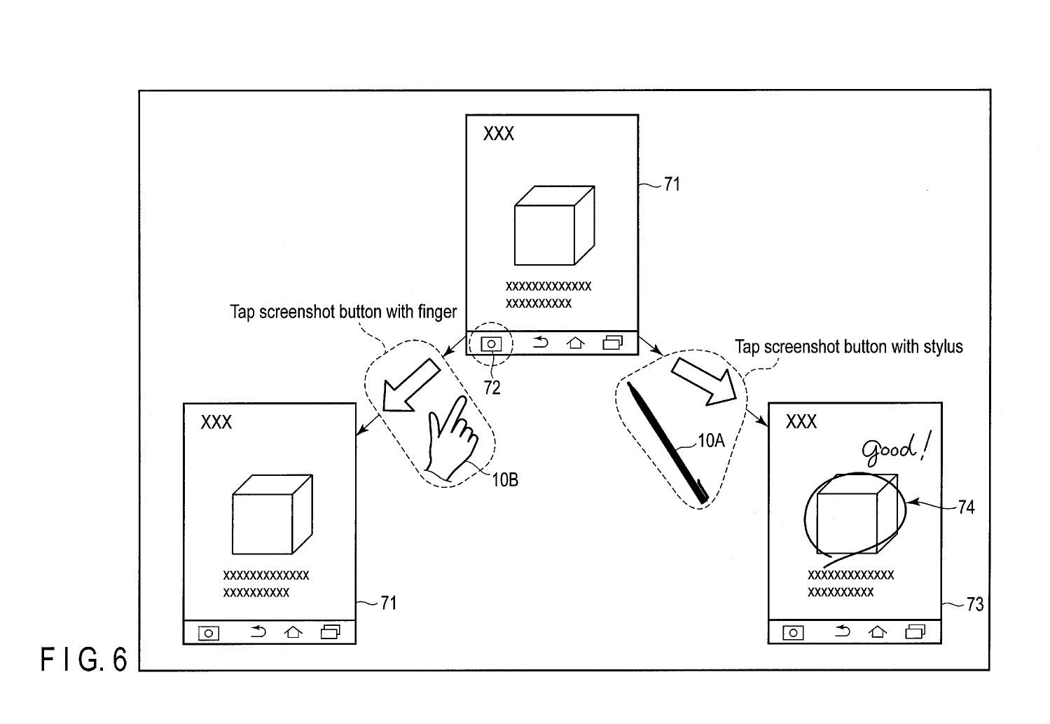

Examples of operations of the application program 202 or the OS 201 according to each of the operation with a finger 10B and that with the stylus 10A will be described with reference to FIG. 4, FIG. 5 and FIG. 6.

A slide button 52 (object) for giving an instruction to release a lock is provided on screen 51 shown in FIG. 4. In the slide button 52, screen 51 is unlocked in accordance with an operation of, for example, sliding a button (knob) 52A from left to right. If the button 52A is slid with the finger 10B (the lock is released with the finger 10B), a desktop screen 54 (also called a home screen) on which any of a plurality of application programs can be launched is displayed, and if the button 52A is slid with the stylus 10A (the lock is released with the stylus 10A), an application program for creating a handwritten document is launched, and screen 55 for handwritten document creation is displayed.

More specifically, the OS 201 issues an event indicating that an operation of sliding the button 52A from left to right using the finger 10B has been performed when the operation of sliding the button 52A from left to right is detected by the touch panel (first sensor) 17B using the finger 10B. The detector 31 (for example, the detector 31 provided in the OS 201) receives (detects) the event issued by the OS 201 and outputs it to the execution controller 32.

Then, the execution controller 32 (for example, the execution controller 32 provided in the OS 201) displays the desktop screen 54 when the event indicates that the operation of sliding the button 52A from left to right has been performed using the finger 10B. For example, icons 54A for giving an instruction to launch various applications are displayed on the desktop screen 54. Since each of the icons 54A is displayed in a size suitable for the touch operation with the finger 10B, the user can easily give an instruction to launch an application corresponding to the icon 54A.

Further, the OS 201 issues an event indicating that an operation of sliding the button 52A from left to right using the stylus 10A has been performed when the operation of sliding the button 52A from left to right is detected by the digitizer (second sensor) 17C using the stylus 10A. The detector 31 receives (detects) the event issued by the OS 201 and outputs it to the execution controller 32.

Then, the execution controller 32 launches an application program for creating a handwritten note (note application) when the event indicates that the operation of sliding the button 52A from left to right using the stylus 10A has been performed. Screen 55 for creating the handwritten note is displayed in response to the application program for creating the handwritten note being launched. The user can write a character or a figure on screen 55 by hand with, for example, the stylus 10A.

According to the above structure, if a lock is released with the finger 10B, the desktop screen 54 is displayed, and if the lock is released with the stylus 10A, screen 55 for the handwritten note is displayed. Thus, if the lock is released with the finger 10B, the user can select one of the icons 54A on the desktop screen 54 and give an instruction to launch a corresponding application, and if the lock is released with the stylus 10A, the user can immediately begin writing a note by hand on displayed screen 55.

Further, a retrieval button 62 (object) for giving an instruction for retrieval is provided on a screen 61 shown in FIG. 5. The retrieval button 62 is used for, for example, giving an instruction to start inputting a character (character string), a symbol, a figure, etc., used as a retrieval key. If the retrieval button 62 is tapped (touched) with the finger 10B, input area 65 for inputting a retrieval key at a keyboard is displayed. If the retrieval button 62 is tapped with the finger 10B, a software keyboard 66 may be further displayed. If the retrieval button 62 is tapped (touched) with the stylus 10A, input area 68 for inputting a handwritten retrieval key is displayed.

More specifically, the OS 201 issues an event indicating that an operation of tapping the button 62 using the finger 10B has been performed when the operation of tapping the button 62 using the finger 10B is detected by the touch panel (first sensor) 17B. The detector 31 (for example, the detector 31 provided in an application 202) receives (detects) the event issued by the OS 201 and outputs it to the execution controller 32.

Then, the execution controller 32 (for example, the execution controller 32 provided in the application 202) displays the software keyboard 66 and retrieval screen 64 on which keyboard input (text input) is possible when the event indicates that an operation of tapping the button 62 using the finger 10B has been performed. It should be noted that the execution controller 32 may request (instruct) the application 202 to execute a corresponding command (or function, program, etc.) to display the software keyboard 66 and retrieval screen 64 on which keyboard input is possible. For example, input area 65 for keyboard input and the retrieval button 62 for giving an instruction to execute retrieval are provided on retrieval screen 64 on which keyboard input is possible. The user can input a retrieval key (character string) in input area 65 by tapping a key (button) on the software keyboard 66, and instruct the application 202 to perform retrieval in which the input retrieval key is used (for example, web retrieval, file retrieval, document retrieval or image retrieval) by tapping the retrieval button 62, for example.

Further, the OS 201 issues an event indicating that an operation of tapping the button 62 using the stylus 10A has been performed when the operation of tapping the button 62 using the stylus 10A is detected by the digitizer (second sensor) 17C. The detector 31 receives (detects) the event issued by the OS 201 and outputs it to the execution controller 32.

Then, the execution controller 32 displays retrieval screen 67 on which handwritten input is possible when the event indicates that an operation of tapping the button 62 with the stylus 10A has been performed. It should be noted that the execution controller 32 may request (instruct) the application 202 to execute a corresponding command (or function, program, etc.) to display retrieval screen 67 on which handwritten input is possible. For example, input area 68 for writing by hand and the retrieval button 62 for giving an instruction to execute retrieval are provided on retrieval screen 67 on which handwritten input is possible. The user can input a retrieval key (character string, symbol, figure, etc.) by making strokes by hand in input area 68 using the stylus 10A, and instruct the application 202 to perform retrieval in which the input retrieval key is used (for example, web retrieval, file retrieval, document retrieval or image retrieval) by tapping the retrieval button 62, for example.

According to the above structure, if the retrieval button 62 is tapped with the finger 10B, the software keyboard 66 and retrieval screen 64 on which keyboard input (text input) is possible is displayed, and if the retrieval button 62 is tapped with the stylus 10A, retrieval screen 67 on which handwritten input is possible is displayed. Then, the user can input a retrieval key using a software keyboard if the retrieval button 62 is tapped with the finger 10B, and can input a handwritten retrieval key if the retrieval button 62 is tapped with the stylus 10A. Thus, an intuitive user interface suitable for each of the input with the finger 10B and that with the stylus 10A can be provided without providing a button, etc., for switching between keyboard input and handwritten input on a screen.

It should be noted that the OS 201 may further issue an event indicating that an operation of tapping input area 65 using the stylus 10A has been performed when the operation of tapping input area 65 using the stylus 10A is detected by the digitizer (second sensor) 17C. The detector 31 receives (detects) the event issued by the OS 201 and outputs it to the execution controller 32. The execution controller 32 can also display retrieval screen 67 (input area 68) on which handwritten input is possible when the event indicates that the operation of tapping input area 65 using the stylus 10A has been performed.

Next, a screenshot button 72 (object) for giving an instruction to store at least a part of the screen of the LCD 17A (for example, a screenshot of an image of the screen) is provided on a screen 71 shown in FIG. 6. If the screenshot button 72 is tapped (touched) with the finger 10B, at least a part of the screen of the LCD 17A is stored, and if the screenshot button 72 is tapped (touched) with the stylus 10A, a program for writing by hand on at least a part of the screen of the LCD 17A is executed, and strokes made by hand and at least a part of the screen are stored.

More specifically, the OS 201 issues an event indicating that an operation of tapping the button 72 using the finger 10B has been performed when the operation of tapping the button 72 using the finger 10B is detected by the touch panel (first sensor) 17B. The detector 31 (for example, the detector 31 provided in the application 202) receives (detects) the event issued by the OS 201 and outputs it to the execution controller 32.

Then, the execution controller 32 (for example, the execution controller 32 provided in the application 202) stores screenshot 71 (image file of the screenshot) of at least a part of the screen of the LCD 17A in a storage medium 41 (storage device 106, etc.) when the event indicates that the operation of tapping the button 72 using the finger 10B has been performed. It should be noted that the execution controller 32 may request (instruct) the application 202 to execute a corresponding command (or function, program, etc.) to store screenshot 71.

Further, the OS 201 issues an event indicating that an operation of tapping the button 72 using the stylus 10A has been performed when the operation of tapping the button 72 using the stylus 10A is detected by the digitizer (second sensor) 17C. The detector 31 receives (detects) the event issued by the OS 201 and outputs it to the execution controller 32.

Then, when the event indicates that the operation of tapping the button 72 has been performed using the stylus 10A, the execution controller 32 executes a program (for example, program providing a user interface [UI] for writing by hand) for writing by hand on at least a part of the screen of the LCD 17A, and stores a handwritten note 74 comprising strokes of characters, a figure, etc., written or drawn by hand, and screenshot 73 of at least a part of the screen in the storage medium 41. The execution controller 32 sets an input area in which an image currently displayed on the screen is made transparent on, for example, at least a part of the screen by executing the program. This enables the user to write a character or a figure by hand in this input area. It should be noted that the execution controller 32 may request (instruct) the application 202 to execute a corresponding command (or function, program, etc.) to execute a program for writing by hand and to store screenshot 73 containing the handwritten note 74.

According to the above structure, if the screenshot button 72 is tapped with the finger 10B, screenshot 71 of the screen of the LCD 17A is stored, and if the screenshot button 72 is tapped with the stylus 10A, the UI for writing by hand is provided on the screenshot of the screen of the LCD 17A, and screenshot 73 containing the handwritten note 74 is stored. Then, the user can store screenshot 71 of the screen if the screenshot button 72 is tapped with the finger 10B, and can add a handwritten note to screenshot 71 of the screen and store screenshot 73 containing the handwritten note 74 if the screenshot button 72 is tapped with the stylus 10A.

In this embodiment, processing according to the input with the finger 10B and that according to the input with the stylus 10A can be associated with various objects, as in the operations shown in FIG. 4, FIG. 5, and FIG. 6.

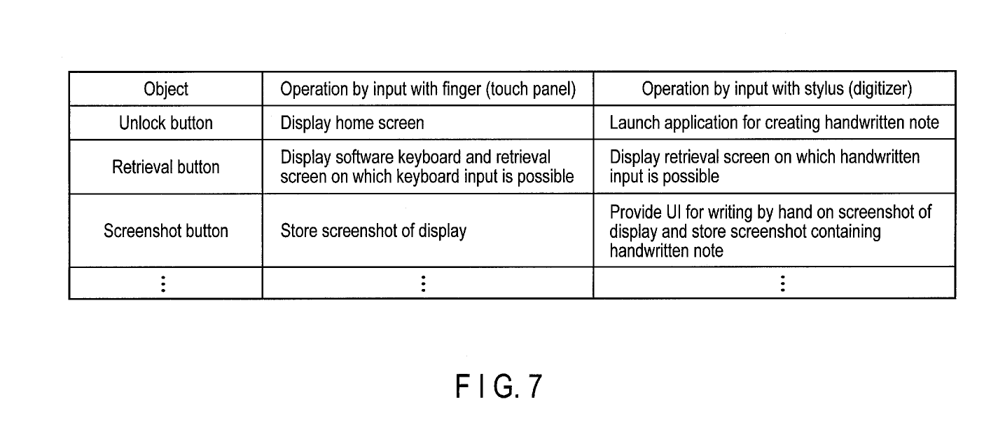

FIG. 7 shows an example of an operation table comprising operation information indicating that an operation according to the input (first operation) with the finger 10B (first processing) and that according to the input (second operation) with the stylus 10A (second processing) are associated with objects. In this operation table, the input with the finger 10B, that is, an operation according to the input detected by the touch panel 17B and the input with the stylus 10A, that is, an operation according to the input with the digitizer 17C are associated with each of the objects. The operation table is stored in, for example, the storage medium 41.

In the operation table, “display home screen” is associated as the operation by the input with the finger 10B and “launch application for creating handwritten note” is associated as the operation by the input with the stylus 10A, with the slide button (unlock button) 52, as in, for example, the example shown in FIG. 4. Further, “display software keyboard and retrieval screen on which keyboard input is possible” is associated as the operation by the input with the finger 10B and “display retrieval screen on which handwritten input is possible” is associated as the operation by the input with the stylus 10A, with the retrieval button 62, as in the example shown in FIG. 5. Furthermore, “store screenshot of display” is associated as the operation by the input with the finger 10B and “provide UI for writing by hand on screenshot of display and store screenshot containing handwritten note” is associated as the operation by the input with the stylus 10A, with the screenshot button 72, as in the example shown in FIG. 6.

The execution controller 32 reads operation information (entry) corresponding to an object from the operation table stored in the storage medium 41 if input (operation) for the object is detected. Then, the execution controller 32 performs control based on the read operation information such that either the operation associated with the input with the finger 10B or that associated with the input with the stylus 10A is executed. That is, the execution controller 32 executes the operation (first processing) associated with the input with the finger 10B if the input with the finger 10B (first operation) is detected, and executes the operation (second processing) associated with the input with the stylus 10A if the input with the stylus 10A (second operation) is detected, based on the read operation information.

It should be noted that the above-described operation table is an example, and various operations according to the input with the finger 10B and that with the stylus 10A can be associated with various objects. In the operation table, not only contents of the operations as described above but also a command, a function, a program, etc., for performing the operations may be associated with the objects. Further, the operation information included in the operation table may be defined by the application 202 or the OS 201 and may be set by the user using a setting screen, etc., for setting the operation information. Furthermore, the operation according to the input with the finger 10B and that according to the input with the stylus 10A can be associated with each of a plurality of objects displayed on one screen.

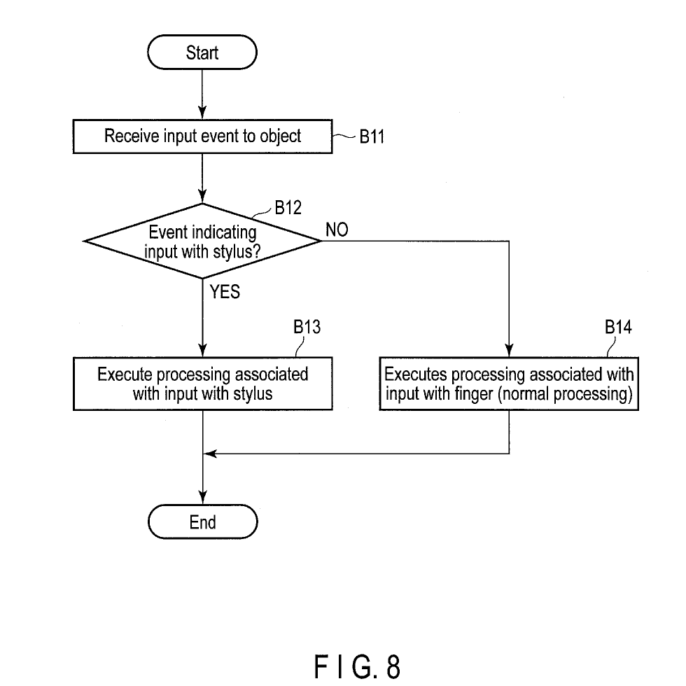

Next, an example of procedures of input processing executed by the application program 202 (or the OS 201) will be described with reference to the flowchart of FIG. 8.

First, the detector 31 receives an input event to an object displayed on the screen of the LCD 17A from the OS 201 (block B11). The detector 31 receives, for example, an input event according to a touch operation to the screen with the finger 10B (that is, input event according to a touch operation detected by the touch panel 17B) or an input event according to a touch operation to the screen with the stylus 10A (that is, input event according to a touch operation detected by the digitizer 17C).

Next, the execution controller 32 determines whether the input event received by the detector 31 is an event indicating the input with the stylus 10A or not (block B12). The input event comprises, for example, various parameters representing contents of the event. The execution controller 32 can determine by use of the parameters whether the input event is the event indicating the input with the stylus 10A or that indicating the input with the finger 10B, etc.

If the input event is the event indicating the input with the stylus 10A (YES in block B12), the execution controller 32 executes processing associated with the input with the stylus 10A (block B13). On the other hand, if the input event is not the event indicating the input with the stylus 10A (NO in block B12), that is, if the input event is the event indicating the input with the finger 10B, the execution controller 32 executes processing associated with the input with the finger 10B (for example, normal processing of the application 202 or the OS 201) (block B14). Examples of the processing associated with the input with the stylus 10A and that associated with the input with the finger 10B are described with reference to FIG. 4, FIG. 5, FIG. 6 and FIG. 7.

As described above, this embodiment allows a function suitable for the operation with the finger and that with the stylus to be provided when each of the operations is performed on a touchscreen display. The touchscreen display 17 comprises the touch panel (first sensor) 17B and the digitizer (second sensor) 17C, and displays an object on a screen. The detector 31 detects the first operation to the object through the touch panel 17B (for example, operation with the finger 10B), and detects the second operation to the object through the digitizer 17C (for example, operation with the stylus 10A). The execution controller 32 executes the first processing if the first operation is detected, and executes the second processing different from the first processing if the second operation is detected. This allows a function suitable for each of the first operation and the second operation to be provided.

It should be noted that all procedures of the input processing of this embodiment can be executed by software. Thus, an advantage similar to that of this embodiment can be easily realized merely by installing a program that executes the procedures of the input processing in a normal computer through a computer-readable, non-transitory storage medium storing the program and by executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a touchscreen display comprising a first sensor and a second sensor, and configured to display an user interface on a screen; and
circuitry configured to:
execute a first process when a first operation to the user interface through the first sensor is detected; and
execute a second process different from the first process when a second operation to the user interface through the second sensor is detected.

2. The apparatus of claim 1, wherein:
the first sensor is configured to detect contact between a finger and the touchscreen display; and
the second sensor is configured to detect contact between a stylus and the touchscreen display.

3. The apparatus of claim 2, wherein:
the first sensor comprises a touch panel; and
the second sensor comprises a digitizer.

4. The apparatus of claim 1, wherein the circuitry is configured to store operation information indicating that the first process according to the first operation and the second process according to the second operation are associated with the user interface, and
the circuitry is configured to execute the first process when the first operation is detected, and to execute the second process when the second operation is detected, based on the operation information.

5. The apparatus of claim 1, wherein:
the user interface comprises an user interface for giving an instruction to release a lock;
the first process comprises a process of displaying a screen on which one of a plurality of application programs is launchable; and
the second process comprises a process of launching an application program for creating a handwritten document.

6. The apparatus of claim 1, wherein:
the user interface comprises an user interface for giving an instruction for retrieval;
the first process comprises a process of displaying an input area for inputting a retrieval key at a keyboard; and
the second process comprises a process of displaying an input area for inputting a handwritten retrieval key.

7. The apparatus of claim 1, wherein:
the user interface comprises an user interface for giving an instruction to store at least a part of the screen;
the first process comprises a process of storing at least a part of the screen; and
the second process comprises a process of executing a program for writing by hand on at least a part of the screen, and of storing a stroke made by hand and at least a part of the screen.

8. An input method which uses touchscreen display comprising a first sensor and a second sensor and displaying an user interface on a screen, the method comprising:
executing a first process when a first operation to the user interface through the first sensor is detected; and
executing a second process different from the first process when a second operation to the user interface through the second sensor is detected.

9. A computer-readable, non-transitory storage medium having stored thereon a computer program which is executable by a computer connected to a touchscreen display comprising a first sensor and a second sensor and displaying an user interface on a screen, the computer program controlling the computer to execute functions of:
executing a first process when a first operation to the user interface through the first sensor is detected; and
executing a second process different from the first process when a second operation to the user interface through the second sensor is detected.
